(19) United States
(12) Patent Application Publication
(10) Pub. No.: US 2006/0114290 A1
(43) Pub. Date: Jun. 1, 2006

(54) Inkjet printer

(75) Inventor: Jin-ho Park, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/235,072

(22) Filed: Sep. 27, 2005

(30) Foreign Application Priority Data
Nov. 27, 2004 (KR) 10-2004-0098357

(51) Int. Cl. B41J 2/14

(52) U.S. Cl. 347/50

(57) ABSTRACT

An inkjet printer includes a print head having a width corresponding to a width of a sheet of paper. The print head has a plurality of nozzle sections. A plurality of contact devices correspond to the nozzle sections. The contact devices operate independently of each other.

### CROSS-REFERENCE TO RELATED APPLICATIONS

This application claims the benefit under 35 U.S.C. §119(a) of Korean Patent Application No. 10-2004-0098357, filed on Nov. 27, 2004, in the Korean Intellectual Property Office, the entire disclosure of which is hereby incorporated by reference.

### BACKGROUND OF THE INVENTION

1. Field of the Invention

The present invention relates to an inkjet printer. More particularly, the present invention relates to an inkjet printer having a contact structure on a print head that is substantially as wide as a sheet of paper.

2. Description of the Related Art

Generally, an inkjet printer forms an image by ejecting droplets of ink through a print head suspended above the surface of a sheet of paper. The print head shuttles perpendicularly to the paper's transport direction, and, thus, such inkjet printers are called shuttle type printers.

FIG. 1 is an exploded perspective view of an ink cartridge 10 with an electrical contact device and a carrier 20, which are included in a conventional shuttle type printer. FIG. 2 is a sectional view of a plurality of contact points 12 of the ink cartridge 10 of FIG. 1 and a plurality of contact points 22 of a flexible printed circuit board (PCB) 26.

Referring to FIGS. 1 and 2, the inkjet printer includes the ink cartridge 10, the carrier 20, and the flexible PCB 26. The ink cartridge 10 includes a nozzle unit which ejects ink. The ink cartridge 10 is loaded into the carrier 20, which then moves horizontally. The flexible PCB 26 transmits electrical signals between the ink cartridge 10 and the carrier 20.

The contact points 12 are formed on one side of the ink cartridge 10 to be electrically connected to the flexible PCB 26. The carrier 20 includes a PCB 24, which exchanges electrical signals with a main board of a computer, on its inner surface. The PCB 24 is electrically connected to one end of the flexible PCB 26. The contact points 22 corresponding to the contact points 12 of the ink cartridge 10 are formed on the flexible PCB 26.

The contact points 22 of the flexible PCB 26 must protrude to contact the contact points 22 of the ink cartridge 10 when the ink cartridge 10 is loaded into the carrier 20. To this end, an elastic rubber member 30 is installed beneath the flexible PCB 26. A plurality of protrusions 32 corresponding to the protruding contact points 22 of the flexible PCB 26 are formed on the elastic rubber member 30.

Recently, a printer with a line array print head has been suggested. Such a printer includes a nozzle unit substantially as wide as a sheet of paper and performs consecutive printing in the direction that the paper moves. Since the nozzle unit of the printer with a line array print head is as wide as a sheet of paper, the contact point unit electrically connected to the nozzle unit may also be as wide as the sheet of paper.

If the contact point unit is formed as a single member, however, when the contact point unit is pressed against the nozzle unit, a portion of the contact point unit or a portion of the nozzle unit may become bent or deformed. In this case, since no contact force is applied to the bent or deformed portion, ink is not properly ejected from the nozzle unit. A greater force may be applied to make the nozzle unit contact the contact point unit. The greater force may, however, break the member.

Accordingly, there is a need for a nozzle unit with an improved contract structure in an inkjet printer having a print head that is as wide as a sheet of paper that is being printed on.

### SUMMARY OF THE INVENTION

An aspect of the present invention is to solve at least the above problems and/or disadvantages and to provide at least the advantages described below. Accordingly, an aspect of the present invention is to provide an inkjet printer including a plurality of contact point devices in which contact loads are respectively imposed on a plurality of contact point units to facilitate electrical connections.

According to an aspect of the present invention, an inkjet printer includes a print head having a width corresponding to a width of a sheet of paper. The printer has a plurality of nozzle sections; and a plurality of contact devices corresponding to the nozzle sections. The contact devices preferably operate independently of one another.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is an exploded perspective view of an ink cartridge including an electrical contact device and a carrier, which are included in a conventional shuttle type printer;

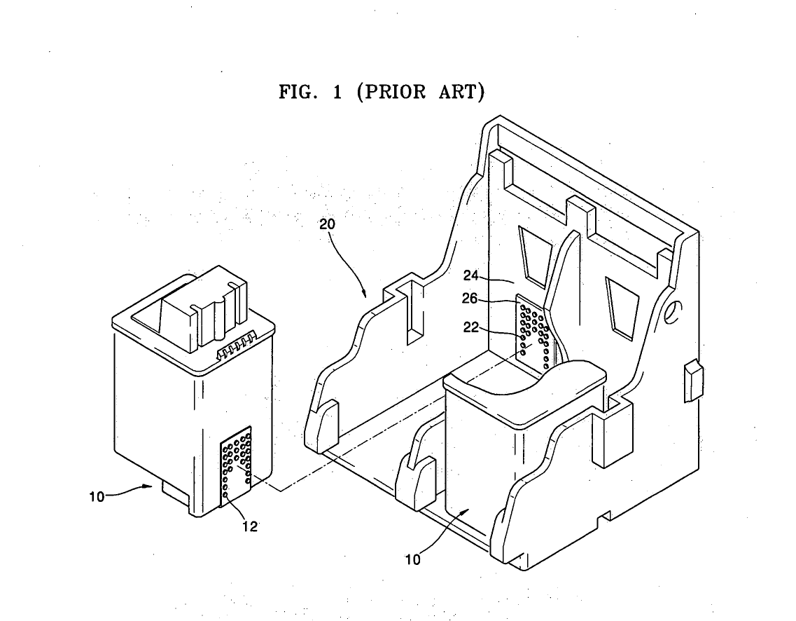

FIG. 2 is a sectional view of a plurality of contact points of the ink cartridge of FIG. 1 and a plurality of contact points of a flexible printed circuit board (PCB);

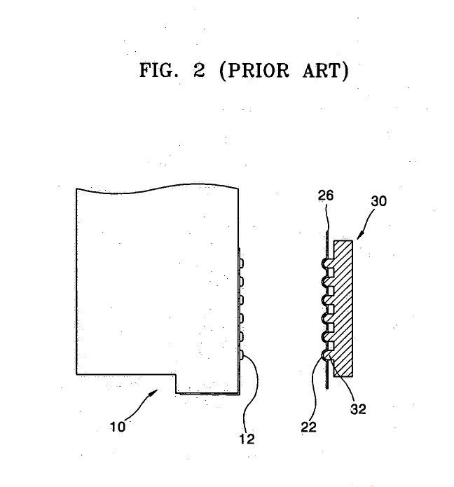

FIG. 3 is a schematic perspective view of an inkjet printer including a plurality of contact devices according to an embodiment of the present invention;

FIG. 4 is a bottom view of one of the contact devices of FIG. 3;

FIG. 5 is view of the contact device taken along line I-I′ of FIG. 3; and

FIG. 6 is a bottom view of a contact device.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

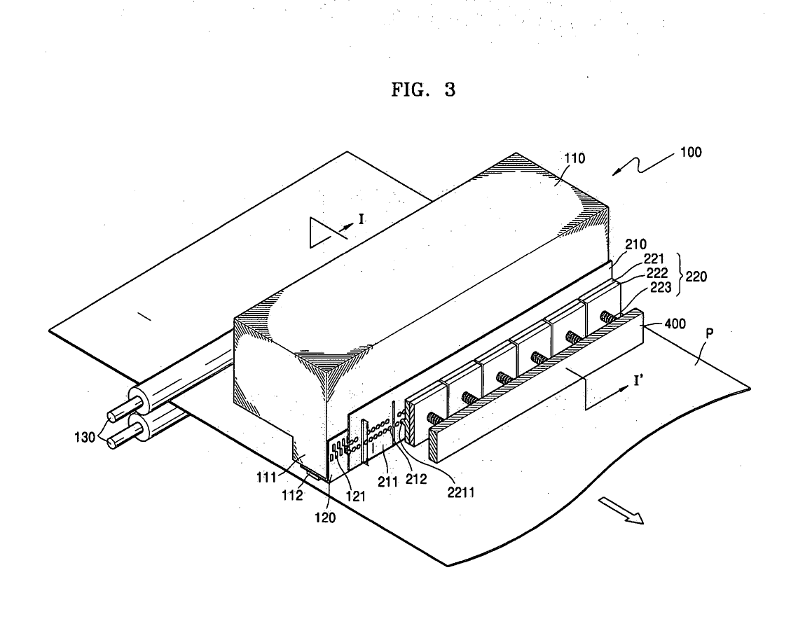

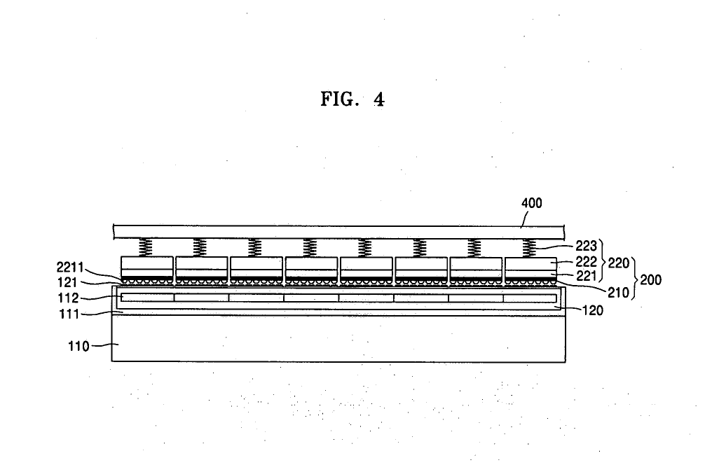

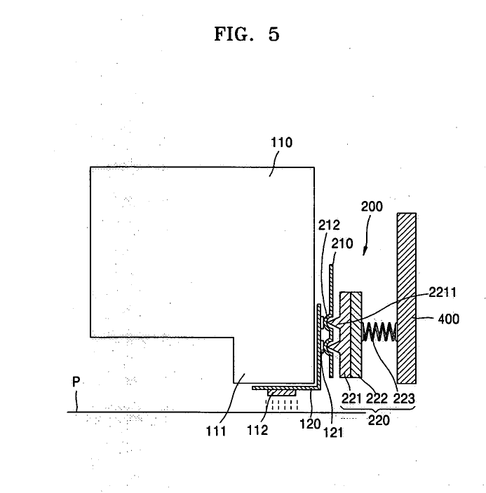

Referring to FIGS. 3 through 5, an inkjet printer 100 includes a print head 110, a plurality of contact devices 200, and a transport roller 130. The print head 110 has a width corresponding to a width of a sheet of paper P. The print head 110 includes a nozzle unit 111 including a plurality of nozzle sections 112 in a lower part thereof. A contact point unit 120 is electrically connected to the nozzle sections 112 and includes a plurality of nodes 121.

The contact devices 200 contact the nodes 121 of the contact point unit 120 to form an electrical connection and transmit an electrical signal corresponding to an image signal to the nodes 121 of the contact point unit 120. The contact devices 200 include a printed circuit board (PCB) 210 and an elastic member 220.

The PCB 210 receives an electrical signal corresponding to an image signal and includes a plurality of contact point sections 211. The contact sections 211 are formed by incising the PCB 210 a predetermined length I from an edge of the PCB 210 in a direction perpendicular to the sheet of paper P. The contact point sections 211 include a plurality of protruding nodes 212. Since the contact point sections 211 are separated from one another, they can operate independently without interfering with one another.

The predetermined length I by which the PCB 210 is incised from the edge of the PCB 210 may be sufficient to allow each of the neighboring contact sections 211 to operate without interfering with operations of the other neighboring contact point sections 211.

The elastic members 220 press the contact point sections 211 toward the contact point unit 120 to make an electrical connection. Each of the elastic members 220 includes a pressing unit 221, a supporting unit 222, and a spring unit 223.

The pressing units 221 are attached to the supporting units 222, and each of the pressing units 221 includes a plurality of protrusions 2211 corresponding to the nodes 212 of the contact point sections 211. The protrusions 2211 press the nodes 212 of the PCB 210 into contact with the nodes 121 of the contact point unit 120. The protrusions 2211 may be formed of an elastic material such that they can easily contact the nodes 121 of the contact point unit 120. The shapes of the nodes 212 of the contact point sections 211 and those of the protrusions 2211 are not limited in the present invention, and there may be various changes in the shapes of the nodes 212 and the protrusions 2211.

The supporting units 222 are interposed between the pressing units 221 and the spring units 223, and deliver the force of the spring units 223 to the pressing units 221 through their connection with the spring units 223. The spring units 223 press the supporting units 222 and the pressing units 221 toward the contact point unit 120 of the print head 110 with respect to a body frame 400.

The elastic members 220 correspond to the contact point sections 221 such that the force of the spring units 223 works on the contact point sections 221. Therefore, independent contact loads can be imposed on the contact point sections 221, and thus the contact point sections 221 are not affected by one another.

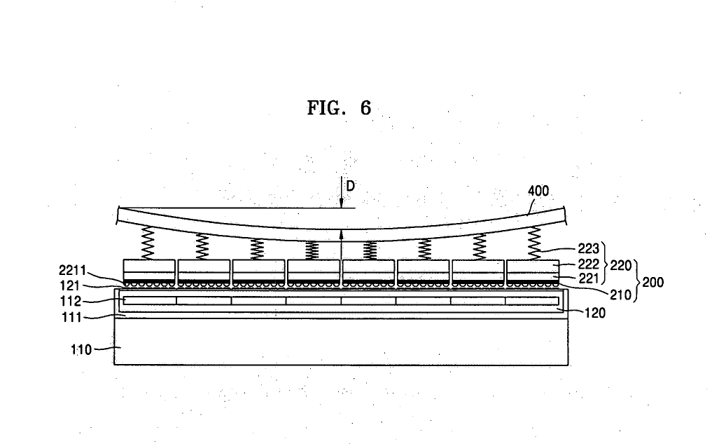

Referring to FIG. 6, even when the body frame 400 is bent by an amount D, the contact point sections 221 can contact the contact point unit 120 due to the independent contact loads on the contact point sections 221, since the contact point sections 221 are pressed toward the contact point unit 120 by the spring units 223. The transport roller 130 conveys the sheet of paper P to the print head 110 such that an image can be formed on the sheet of paper P by the nozzle unit 111.

As described above, an inkjet printer according to the present invention includes a plurality of contact devices contacting a plurality of contact point units of a print head. Thus, the contact devices can operate independently, ensuring reliable electrical connections.

While the invention has been shown and described with reference to certain embodiments thereof, it will be understood by those skilled in the art that various changes in form and details may be made therein without departing from the spirit and scope of the invention as defined by the appended claims.

What is claimed is:

1. An inkjet printer comprising:
a print head having a width substantially corresponding to a width of a sheet of paper and comprising a plurality of nozzle sections; and
a plurality of contact devices respectively corresponding to the nozzle sections and operating independently of one another.

2. The inkjet printer of claim 1, wherein each of the contact devices comprises:
a printed circuit board comprising a plurality of contact point sections, each contact point section having a plurality of nodes contacting contact units of the nozzle sections; and
a plurality of elastic members pressing the contact point sections against the contact point units of the nozzle sections to bring them into contact with each other.

3. The inkjet printer of claim 2, wherein each of the elastic members comprises:
a pressing unit installed to contact one of the contact point sections;
a supporting unit supporting the pressing unit; and
a spring unit pressing the supporting unit toward the pressing unit.

4. The inkjet printer of claim 3, wherein
the spring unit is supported by a body frame and is a compression spring.

5. The inkjet printer of claim 3, wherein
the elastic members are separated from one another so as not to interfere with each other.

6. The inkjet printer of claim 2, wherein
the contact point sections are separated from one another by incising the printed circuit board.

7. The inkjet printer of claim 6, wherein
a length by which the printed circuit board is incised from an edge of the printed circuit board is sufficient to allow each of the neighboring contact point sections to operate without interfering with operations of the other neighboring contact point sections.

8. The inkjet printer of claim 6, wherein
the printed circuit board is incised from the edge of the printed circuit board.

9. An inkjet printer comprising:
a print head having a width substantially corresponding to a width of a sheet of paper and comprising a plurality of nozzle sections, each nozzle section having a contact point unit with a plurality of nodes;
a printed circuit board including a plurality of contact point sections, each contact point section corresponding to one of the plurality of nozzle sections, and each contact point section having nodes contacting the nodes of the corresponding nozzle section; and
a plurality of elastic members pressing the contact point sections against the contact point units of the nozzle sections to bring them into contact with each other.

10. The inkjet printer of claim 9, wherein each of the elastic members comprises:
a pressing unit installed to contact one of the contact point sections;
a supporting unit supporting the pressing unit; and
a spring unit pressing the supporting unit toward the pressing unit.

11. The inkjet printer of claim 10, further comprising
a body frame that supports the spring unit.

12. The inkjet printer of claim 11, wherein
the spring unit is a compression spring.

13. The inkjet printer of claim 10, wherein
the elastic members are separated from one another so as not to interfere with each other.

14. The inkjet printer of claim 9, wherein
the contact point sections are separated from one another by incising the printed circuit board.

15. The inkjet printer of claim 14, wherein
a length by which the printed circuit board is incised from an edge of the printed circuit board is sufficient to allow each of the neighboring contact point sections to operate without interfering with operations of the other neighboring contact point sections.

16. The inkjet printer of claim 14, wherein
the printed circuit board is incised from the edge of the printed circuit board.

17. The inkjet printer of claim 9, wherein
the contact point sections are separated from one another so that they operate independently of one another.
